(19) United States
(12) Patent Application Publication
(10) Pub. No.: US 2010/0035567 A1
(43) Pub. Date: Feb. 11, 2010

(54) ANTENNA FOR MOBILE TERMINAL AND METHOD FOR CHANGING RADIATION PATTERN USING THE SAME

(75) Inventor: Young-Boo VIN, Suwon-si (KR)

Correspondence Address: Jefferson IP Law, LLP, 1130 Connecticut Ave., NW, Suite 420, Washington, DC, 20036, US

(73) Assignee: Samsung Electronics Co. Ltd., Suwon-si (KR)

(21) Appl. No.: 12/536,003

(22) Filed: Aug. 5, 2009

(30) Foreign Application Priority Data
Aug. 6, 2008 (KR) 10-2008-0076930

(51) Int. Cl. H04B 17/00; H01Q 3/24; H01Q 1/38

(52) U.S. Cl. 455/115.3; 343/876; 343/700 MS

(57) ABSTRACT

An antenna of a mobile terminal and a method for changing a radiation pattern of the mobile terminal are provided. The antenna includes an antenna radiator including at least two different feeding points, a Radio Frequency (RF) receiver selectively connected to one of the at least two different feeding points of the antenna radiator, a switching unit interposed between the RF receiver and the antenna radiator for electrically connecting one of the at least two different feeding points to the RF receiver, and a controller for controlling the switching unit using a Received Signal Strength Indicator (RSSI) value determined at a path connected to the feeding point of the antenna radiator.

### PRIORITY

This application claims the benefit under 35 U.S.C. §119(a) of a Korean patent application filed in the Korean Intellectual Property Office on Aug. 6, 2008 and assigned Serial No. 10-2008-0076930, the entire disclosure of which is hereby incorporated by reference.

### BACKGROUND OF THE INVENTION

1. Field of the Invention

The present invention relates generally to an antenna for a mobile terminal. More particularly, the present invention relates to an antenna for a mobile terminal having excellent radiation characteristics.

2. Description of the Related Art

Recently, developments in electronic communications have provided a mobile terminal having a slim profile that is lightweight, and miniaturized, and that provides various functions. For example, the mobile terminal has been implemented with a speaker unit and a color display unit of millions of pixels. Also, the mobile terminal has been implemented with a music listening function via a Motion Picture Expert Group Audio Layer-3 (MP3) player. Furthermore, a Digital Multimedia Broadcast function which may receive sky waves is provided in the mobile terminal, as well as various game contents using the display unit.

The mobile terminal includes an antenna for transmitting/receiving signals of various forms. External type antennas which are selectively and retractably installed, such as, a helical antenna radiator and a whip antenna radiator that protrudes to the outside of the mobile terminal, were used in conventional mobile terminals. Currently, mobile terminals have been developed with a built-in antenna which is installed in a predetermined position inside the mobile terminal.

The built-in antenna technology has developed from a monopole antenna, having only a feeding point, to a Planar Inverted F Antenna (PIFA), having both a feeding point and a grounding point.

Performance of the built-in antenna is very sensitive to radio wave environments, such as, a Ground (GND) influence and noise. Even when performance of an antenna has been optimized in an existing free space, characteristics of the antenna are changed and the performance is deteriorated by contact of a user's hand or head while the user grips the mobile terminal during communication. Accordingly, when the antenna is fixed, the radiation pattern is also fixed. However, when a user's hand or head is located in a radiating direction where a fixed radiation pattern gain is high, a radio wave is attenuated and the direction of an entire radiation pattern is changed. Therefore, the performance of the mobile terminal is deteriorated by the changed gain and radiation pattern of the antenna.

Techniques including a smart antenna or an array antenna have been implemented for changing the gain in the direction of a base station antenna. However, since the antenna is installed in an apparatus of a relatively large scale, it is difficult to apply the antenna to a mobile terminal where installation space for an antenna is small.

Therefore, a need exists for an antenna for a mobile terminal and method for changing a radiation pattern using the antenna of the mobile terminal.

### SUMMARY OF THE INVENTION

An aspect of the present invention is to address at least the above-mentioned problems and/or disadvantages and to provide at least the advantages described below. Accordingly, an aspect of the present invention is to provide an antenna of a mobile terminal and a method for changing a radiation pattern using the same to improve reliability by allowing a constant radiation characteristic regardless of a state of the mobile terminal.

Another aspect of the present invention is to provide an antenna of a mobile terminal and a method for changing a radiation pattern using the same to prevent performance deterioration of the antenna in advance by changing a radiation pattern during an operation of the terminal.

Still another aspect of the present invention is to provide an antenna of a mobile terminal and a method for changing a radiation pattern using the same to maintain an optimum antenna radiation characteristic by selectively switching a feeding position and/or a grounding position of the antenna radiation.

In accordance with an aspect of the present invention, an antenna of a mobile terminal is provided. The antenna includes an antenna radiator comprising at least two different feeding points, a Radio Frequency (RF) receiver selectively connected to one of the at least two different feeding points of the antenna radiator, a switching unit interposed between the RF receiver and the antenna radiator, for electrically connecting one of the at least two different feeding points to the RF receiver, and a controller for controlling the switching unit using a Received Signal Strength Indicator (RSSI) value determined at a path connected to a feeding point of the antenna radiator.

In accordance with another aspect of the present invention, a method for changing a radiation pattern of a mobile terminal which uses an antenna including an antenna radiator having path A which is a feeding path at a first position and path B which is a feeding path at a second position, a switching unit selectively allowing an electrical connection to one of the two paths, and a controller for controlling the switching unit is provided. The method includes determining and storing an RSSI value of path A, after a switching operation, determining and storing an RSSI value of path B, and comparing the determined RSSI values of the respective paths and setting a path having a better RSSI value as a feeding path.

In accordance with still another aspect of the present invention, a method for changing a radiation pattern of a mobile terminal which uses an antenna including an antenna radiator having path A which is a feeding path at a first position and path B which is a feeding path at a second position, a switching unit selectively allowing an electrical connection to one of the two paths, and a controller for controlling the switching unit is provided. The method includes determining and storing an RSSI value of path A, comparing the determined RSSI value of path A with a reference value, and when the RSSI value is greater than the reference value, setting path A as a feeding path.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a rear perspective view of a mobile terminal to which a built-in antenna is applied according to an exemplary embodiment of the present invention;

FIGS. 2A and 2B are block diagrams illustrating a switching status for changing a feeding point of a Planar Inverted F Antenna (PIFA) according to an exemplary embodiment of the present invention;

FIG. 3 is a flowchart illustrating a procedure for changing a feeding point of an antenna according to an exemplary embodiment of the present invention;

FIG. 4 is a flowchart illustrating a procedure for changing a feeding point of an antenna according to an exemplary embodiment of the present invention; and

FIGS. 5A and 5B are graphs illustrating a change in a radiation pattern based on a Digital Code System (DCS) band Bit Error Rate (BER) and channel power of an antenna according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

A slide type terminal is illustrated in exemplary embodiments of the present invention as depicted below. However, the exemplary embodiments of the present invention are not limited thereto and various types of mobile terminals that include antennas may be used.

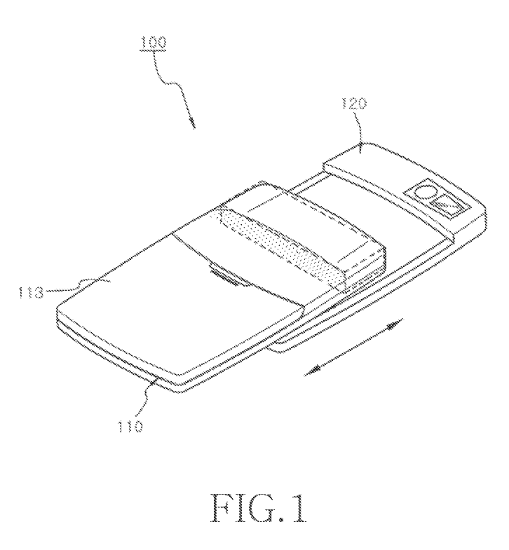

FIG. 1 is a rear perspective view of a mobile terminal to which a built-in antenna is applied according to an exemplary embodiment of the present invention.

Referring to FIG. 1, the slide type mobile terminal 100 includes a main body 110 and a slide body 120. The slide body 120 slides back-and-forth by a certain length along a length direction (arrow direction) of the mobile terminal 100 relative to the main body 110. Conventionally, a built-in antenna is applied to the slide type mobile terminal 100, and disposed at an upper portion (dotted portion in FIG. 1) where a battery pack 113 of the main body 110 is not installed.

In an exemplary implementation, the antenna changes a feeding point of an antenna radiator electrically connected to an RF connector of a main board (not illustrated) depending on the state of the mobile terminal 100. For example, the antenna may change the direction of a pattern by changing the feeding position of the antenna radiator in order to prevent deterioration of a radiation characteristic due to contact from a user's head or a user's finger while a user grips the mobile terminal 100 and communicates on the mobile terminal 100. Accordingly, constant antenna gain may be implemented, thus, achieving excellent reception sensitivity.

Since frequency characteristics of the antenna radiator change depending on the pattern length on the antenna radiator, the length of an entire current path does not change when a feeding position is changed. Therefore, the frequency characteristics of the antenna radiator may be substantially the same.

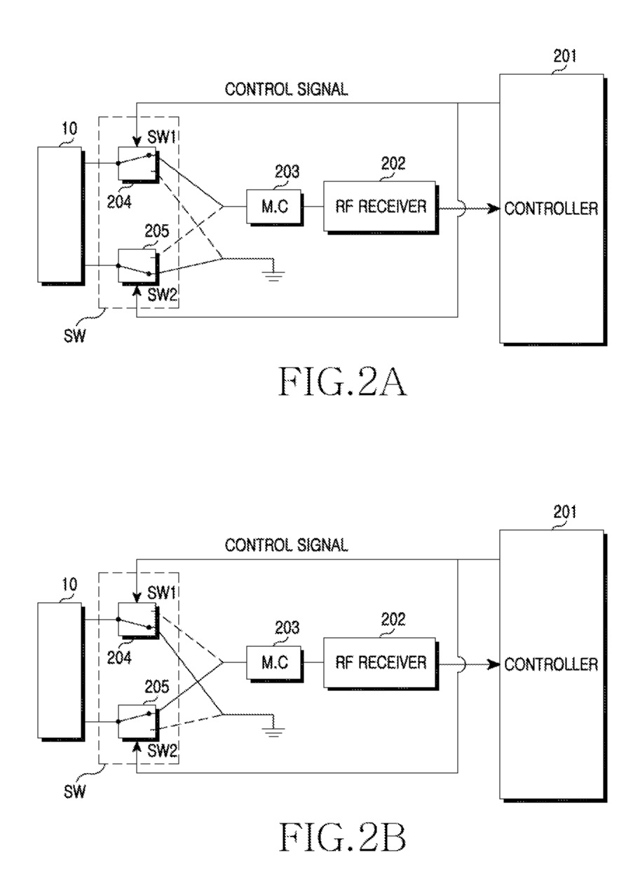

FIGS. 2A and 2B are block diagrams illustrating a switching status for changing a feeding point of a Planar Inverted F Antenna (PIFA) according to an exemplary embodiment of the present invention.

Exemplary embodiments of the present invention describe a PIFA implemented in the mobile terminal. However, the exemplary embodiments of the present invention are not limited thereto and an antenna including a feeding point without a grounding point may also be implemented in the mobile terminal.

Referring to FIGS. 2A and 2B, a feeding point and a grounding point of an antenna radiator 10 are electrically connected to a main board (not illustrated). The feeding point of the antenna radiator may be electrically connected to a Radio Frequency (RF) receiver 202 of the main board, and the grounding point is electrically connected to a grounding body of the main board. Also, the feeding point and the grounding point of the antenna radiator 10 are connected to predefined objects alternately by a predefined Switching unit (SW). The Switching unit (SW) includes a first Switching unit (SW1) 204 and a second Switching unit (SW2) 205. The first Switching unit (SW1) 204 and the second Switching unit (SW2) 205 perform switching operations, simultaneously, so that the feeding point may be alternately connected to the grounding body, and the grounding point may be alternately connected to the RF receiver.

For example, the feeding point of the antenna radiator 10 may be electrically connected to the grounding body of the main board, and the grounding point may be electrically connected to the RF receiver 202 by the operation of the Switching unit (SW). That is, the feeding position of the feeding point may be changed on the antenna radiator 10 by the Switching unit (SW). Construction of the feeding point and the grounding point of the antenna radiator 10 may be implemented using a known switching unit. More particularly, an optimum frequency state may be implemented by providing a matching circuit 203 to the RF receiver 202. The matching circuit 203 may be a passive device. The passive device may include an inductor and a capacitor, for example.

Still referring to FIGS. 2A and 2B, the antenna may have two paths. That is, the antenna may have two different feeding positions and may perform a selective operation to each feeding position using the Switching unit (SW). In an exemplary implementation, it is assumed herein that FIG. 2A illustrates path A and FIG. 2B illustrates path B.

The RF receiver 202 may read a Received Signal Strength Indicator (RSSI) value of the antenna radiator 10. Since the RSSI value changes instantaneously, several measurements per second are made and an accumulated average thereof may be the RSSI value.

The controller 201 determines RSSI values at relevant paths (path A and path B) read by the RF receiver, compares the determined RSSI values, and controls the Switching unit (SW) to use a path having a better RSSI value.

Also, the controller 201 compares a golden received power range set in advance with an RSSI value at a current path. When the RSSI value is less than the golden received power range, the controller 201 may control the Switching unit (SW) to connect a different path.

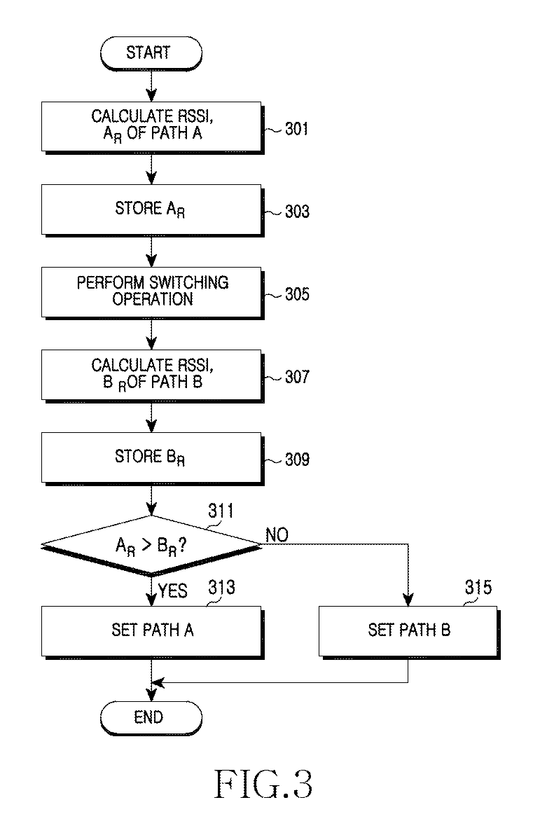

FIG. 3 is a flowchart illustrating a procedure for changing a feeding point of an antenna according to an exemplary embodiment of the present invention.

The procedure may be periodically performed with an interval of a predefined time, or may be performed by an event triggering of the terminal.

Referring to FIG. 3, in step 301, the controller determines an RSSI value of path A using the RF receiver, and in step 303, the controller stores the determined RSSI value. In step 305, the controller performs a switching operation. In step 307, the controller determines an RSSI value of path B using the RF receiver, and in step 309, the controller stores the determined RSSI value. In step 311, the controller compares the stored RSSI values of the respective paths. For example, when the RSSI value of path A is better than the RSSI value of path B, the controller sets path A as a feeding path in step 313. When the RSSI value of path B is better than the RSSI value of path A, the controller sets path B as a feeding path.

In an exemplary implementation, RSSI values of respective paths are collectively determined, the RSSI values of the respective paths are compared with one another, and a path having a better RSSI value is set as a feeding path, so that a better radiation characteristic may be achieved.

For example, even for an antenna in which an optimum radiation characteristic is implemented (path A is set) in a free space, when a user communicates on the mobile terminal and the user grips the mobile terminal or the mobile terminal is attached closely to the user's head, deterioration in a radiation characteristic may occur. In this case, the mobile terminal may prevent an antenna radiation characteristic from being deteriorated by changing the feeding point of the antenna radiator and thus changing the direction of a pattern (path B is set).

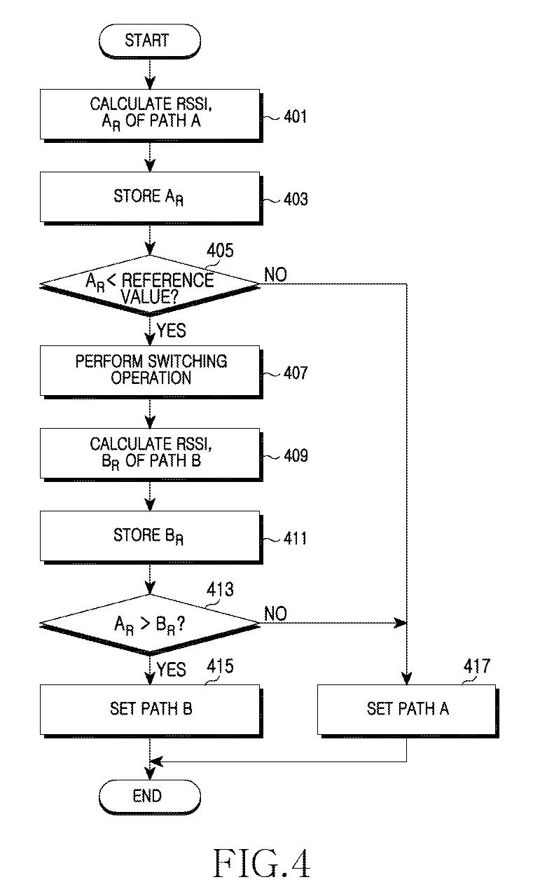

FIG. 4 is a flowchart illustrating a procedure for changing a feeding point of an antenna according to an exemplary embodiment of the present invention.

Referring to FIG. 4, in step 401, the controller determines an RSSI value of path A using the RF receiver, and in step 403, the controller stores the determined RSSI value. In step 405, the controller determines whether the RSSI value of path A is less than a reference RSSI value. When it is determined that the RSSI value of path A is greater than the reference RSSI value in step 405, the controller sets path A as a feeding path without a separate switching operation in step 417. In the above described procedure, the reference value may be set in advance, and when an RSSI value of a relevant path is greater than the reference RSSI value, a separate switching operation is excluded in order to prevent power consumption.

However, when it is determined that the RSSI value of path A is less than the reference RSSI value in step 405, the controller performs a switching operation which switches to path B in step 407. In step 409, the controller determines an RSSI value of path B using the RF receiver, and in step 411, the controller stores the determined RSSI value. In step 413, the controller compares the RSSI value of path A with the RSSI value of path B. When the RSSI value of path A is greater than the RSSI value of path B, the controller sets path A as a feeding path in step 417. When the newly determined RSSI value of path B is greater than the RSSI value of path A, the controller sets path B as a feeding path in step 415.

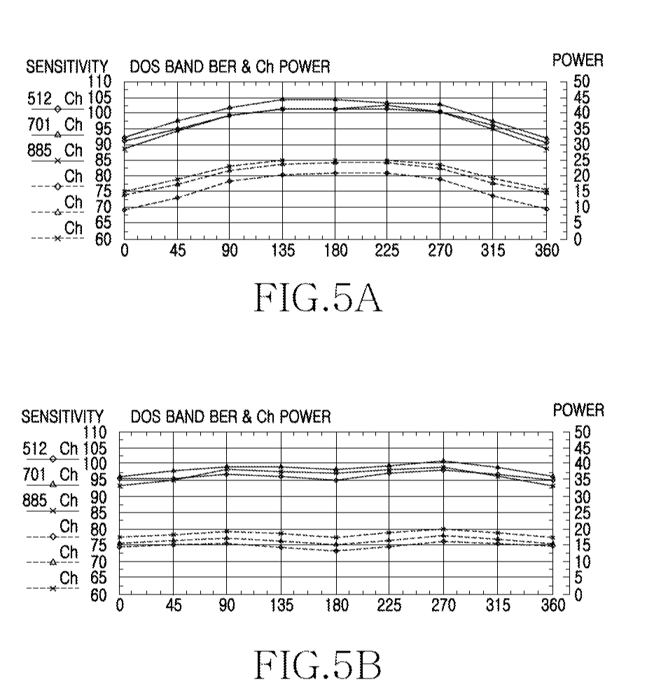

FIGS. 5A and 5B are graphs illustrating a change in a radiation pattern based on a Digital Code System (DCS) band Bit Error Rate (BER) and channel power of an antenna according to an exemplary embodiment of the present invention.

FIG. 5A illustrates results before position changes of the feeding point and the grounding point of the same antenna radiator according to an exemplary embodiment of the present invention, and FIG. 5B illustrates results after the position changes.

Referring to FIG. 5A, the direction of a radiation pattern at a maximum peak is located at about 180 degrees. However, in FIG. 5B, where a relevant path is changed, the direction of the radiation pattern at a maximum peak changes to 270 degrees.

Although the exemplary embodiments of the present invention describe an apparatus and a method for changing two feeding positions of one radiator, two or more feeding positions may be set and a corresponding switching unit may be provided so that a finer radiation pattern change may be induced.

An exemplary antenna properly changes the direction of a radiation pattern using a selective switching operation of a feeding (and/or grounding) position of the radiator and efficiently prevents antenna radiation characteristic deterioration by a user's touch which may occur while a terminal is used, thereby securing reliability of the mobile terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An antenna of a mobile terminal, the antenna comprising:
an antenna radiator comprising at least two different feeding points;
a Radio Frequency (RF) receiver selectively connected to one of the at least two different feeding points of the antenna radiator;
a switching unit interposed between the RF receiver and the antenna radiator, for electrically connecting one of the at least two different feeding points to the RF receiver; and
a controller for controlling the switching unit using a Received Signal Strength Indicator (RSSI) value determined at a path connected to the feeding point of the antenna radiator.

2. The antenna of claim 1, wherein the feeding points comprise two feeding points formed on different positions of the antenna radiator.

3. The antenna of claim 2, wherein the controller determines an RSSI value at each feeding point in turn, compares the determined RSSI values, and controls the switching unit to select a feeding point having a better RSSI value.

4. The antenna of claim 3, wherein the antenna radiator comprises a Planar Inverted F Antenna (PIFA) radiator.

5. The antenna of claim 4, wherein one of the two feeding points of the antenna radiator operates as a grounding point.

6. The antenna of claim 5, wherein, when one of the two feeding points of the antenna radiator operates as a feeding point, the controller controls the switching unit to connect the other feeding point to a ground.

7. The antenna of claim 2, wherein when an RSSI value determined at a current feeding point is less than a reference value, the controller controls the switching unit to be switched to the other feeding point.

8. The antenna of claim 7, wherein the antenna radiator comprises a Planar Inverted F Antenna (PIFA) radiator.

9. The antenna of claim 8, wherein one of the two feeding points of the antenna radiator operates as a grounding point.

10. The antenna of claim 9, wherein, when one of the two feeding points of the antenna radiator operates as a feeding point, the controller controls the switching unit to connect the other feeding point to a ground.

11. A method for changing a radiation pattern of a mobile terminal which uses an antenna comprising an antenna radiator having path A which is a feeding path at a first position and path B which is a feeding path at a second position, a switching unit selectively allowing an electrical connection to one of the two paths, and a controller for controlling the switching unit, the method comprising:
determining and storing a Received Signal Strength Indicator (RSSI) value of path A;
after a switching operation, determining and storing an RSSI value of path B; and
comparing the determined RSSI values of the respective paths and setting a path having a better RSSI value as a feeding path.

12. The method of claim 11, wherein the changing of the radiation pattern is performed by an event triggering of the mobile terminal.

13. The method of claim 11, wherein the changing of the radiation pattern is performed during a certain time period.

14. A method for changing a radiation pattern of a mobile terminal which uses an antenna comprising an antenna radiator having path A which is a feeding path at a first position and path B which is a feeding path at a second position, a switching unit selectively allowing an electrical connection to one of the two paths, and a controller for controlling the switching unit, the method comprising:
determining and storing a Received Signal Strength Indicator (RSSI) value of path A;
comparing the determined RSSI value of path A with a reference value; and
when the RSSI value is greater than the reference value, setting path A as a feeding path.

15. The method of claim 14, further comprising:
when the RSSI value is less than the reference value, performing a switching operation, and determining and storing an RSSI value of path B;
comparing the determined RSSI values of the respective paths; and
when the RSSI value of path B is greater than the RSSI value of path A, setting path B as a feeding path.

16. The method of claim 15, further comprising, when the RSSI value of path B is less than the RSSI value of path A, setting path A as a feeding path.

17. The method of claim 16, wherein the changing of the radiation pattern is performed by an event triggering of the mobile terminal.

18. The method of claim 16, wherein the changing of the radiation pattern is performed during a certain time period.
